(19) United States
(12) Patent Application Publication
(10) Pub. No.: US 2004/0088190 A1
(43) Pub. Date: May 6, 2004

(54) Method for improving the accuracy of transaction data

(76) Inventors: Gina L. Timmons, Englewood, OH (US); Kevin D. Heltsley, Fort Wright, KY (US)

Correspondence Address: Michael A. Forhan, Esq., Thompson Hine LLP, Suite 700, 10 W. Broad St., Columbus, OH, 43215-3435, US

(21) Appl. No.: 10/625,422

(22) Filed: Jul. 23, 2003

Related U.S. Application Data
(60) Provisional application No. 60/414,858, filed on Sep. 30, 2002.

(51) Int. Cl. G06F 17/60

(52) U.S. Cl. 705/2; 705/40; 705/10

(57) ABSTRACT

A method for improving the accuracy of pharmacy transactions. A health care organization's individual health care facilities are linked to a prescription processing center of a publicly-held corporate pharmacy (“PCP”) organization, preferably by means of an electronic communications network. The processing center collects, organizes and correlates patient census data from the health care facilities and transaction data from the pharmacies with existing contract data. The collected and organized data forms a dataset that may be used to determine and allocate the charges. Further, the patient and transaction data may be utilized to generate various reports in an electronic format related to the patients, facilities, and pharmacies.

In another embodiment of the present invention, the electronic communications network may be utilized to survey the health care facilities regarding the level of performance and quality of the PCP and associated pharmacies. This information may be organized into reports and then forwarded to appropriate administrative and management personnel at the health care facility and the PCP.

This application claims the benefit of U.S. Provisional Patent Application No. 60/414,858, filed Sep. 30, 2002.

### FIELD OF THE INVENTION

This invention relates to a method for improving the accuracy of transaction data. Specifically, the invention relates to a method for improving the accuracy of pharmacy transactions.

### BACKGROUND OF THE INVENTION

The practice of pharmacy has undergone radical change in recent years, with a paradigm shift from small, independent pharmacies to regional and national networks of Publicly-held Corporate Pharmacies (“PCPs”). The advent of PCPs was in response to a desire by the industry to minimize the cost of drug therapy while maximizing profitability. Under the PCP system, much of the decision-making power is shifted from health care providers to an administrative organization that establishes standards of care, standardizes methods of delivering care, and evaluates the quality of that care. PCPs strive to minimize costs and maximize profits through a variety of means, including volume purchases, quality control, formularies, movement of market share, and negotiated fees.

A typical PCP system is comprised of a central processing center which serves pharmacies located throughout a region, or even nationwide. The pharmacies, in turn, serve various health care organizations which may be comprised of a number of health care facilities such as nursing homes, hospitals, clinics, physician's offices, and self-insured employers. The health care facilities may also be located throughout a region or nationwide. A PCP system typically includes a data warehousing operation to store the vast amount of transactional data generated by the participating pharmacies. The PCP's central processing center serves as a repository for patient data and pharmacy transactions related to patient care. Although the use of PCPs can provide improved efficiencies, the widely-distributed nature of the various pharmacies and health care facilities increases the potential for errors in pharmacy transactions. A typical error may include inaccurate invoicing of patient accounts by the pharmacy. Types of invoicing errors may include incorrect pricing, incorrect co-pay amounts, and incorrect payment plans.

Under the current practice, invoicing information is provided to a PCP central processing center by the pharmacy via mailed or faxed documents. Typically, the central processing center then sends an invoice to the health care facility. If the health care facility suspects that invoicing errors have been made, the facility must call, fax, or mail a letter to the central processing center, which in turn calls, faxes, or mails a letter to the pharmacy for resolution of the disputed charges. This method of ensuring invoicing accuracy is slow, inefficient, and prone to introducing even more errors. In addition, the current practice may allow some errors to go undetected. An improved method of transmitting and processing pharmacy transaction information is needed to improve the accuracy of transactions and ensure compliance with applicable contracts and insurance plans.

### SUMMARY OF THE INVENTION

A method for improving the accuracy of transaction data is disclosed wherein a health care organization's individual health care facilities, regional-level administrative and management personnel, and corporate-level administrative and management personnel are all linked to a PCP, preferably by means of an electronic communications network such as an intranet or the Internet. The health care organization may be linked to a number of portions of the PCP, such as a processing center, pharmacies and customer service. The processing center collects and organizes patient census data from the health care facilities and transaction data from the pharmacies and organizes the data to form a dataset. The dataset may be used to determine the responsible parties for the charges on the invoice. In addition, pharmacy charges are validated to ensure compliance with applicable pricing schedules, contractual terms, and payment plans for each patient. The health care facility may access the invoices and details of the charges via the electronic communications network, and compare the invoice to the health care facility's records. If an error is discovered, the health care facility may send an electronic request to the central processing center for a credit memo via the electronic communications network.

Further, the patient and transaction data may be utilized to generate reports related to the patients, facilities and pharmacies. The reports may include information regarding high-cost patients, prescription drug usage, and patient and/or pharmacy metrics assessing transactional efficiency. The reports may be obtained via the electronic communications network. However, access to some data, such as patient information, may be restricted on a “need to know” basis to protect privacy. To further protect patient privacy, part or all of the data may be “de-identified” to remove information linking the data to the patient. The availability of data and reports may also be partitioned such that various levels of the health care organization and PCP have visibility only to a predetermined set of data and reports appropriate for each particular level.

In another embodiment, the network may be utilized to survey the health care facilities regarding the level of performance and quality of the PCP organization and the pharmacies. This information may be collected by the central processing center, organized into reports, and then forwarded to appropriate administrative and management personnel at the PCP and at the health care organization, such as quality control and account managers, for taking any necessary corrective action. Similarly, the network may be utilized to obtain customer opinions regarding interest in new products, or the performance of current products.

### BRIEF DESCRIPTION OF THE DRAWINGS

Further features of the present invention will become apparent to those skilled in the art to which the present invention relates from reading the following specification with reference to the accompanying drawings, in which:

FIG. 1 is a block diagram of a method for improving the accuracy of pharmacy transaction data in accordance with an embodiment of the present invention;

FIG. 2 is a block diagram of a method for handling credit memo requests in accordance with an embodiment of the present invention; and

FIG. 3 is a block diagram of a method for handling surveys and customer feedback in accordance with an embodiment of the present invention.

### DESCRIPTION OF THE PREFERRED EMBODIMENT(S)

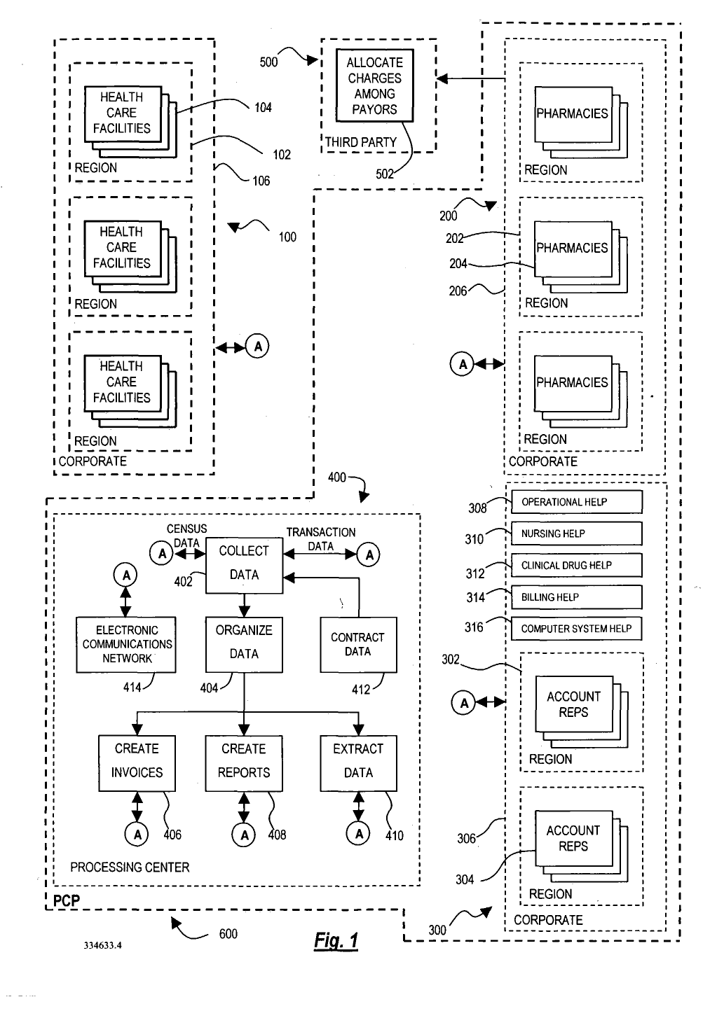

A block diagram of a method for improving the accuracy of pharmacy transaction data according to an embodiment of the present invention is shown in FIG. 1. Health care facilities 104 within a health care organization 100 may be organized into a hierarchy of administrative and management regions 102. The health care organizations 100 may also have a corporate-level administrative and management function 106. In the ordinary course of business, health care facilities 104 will order supplies from one or more pharmacies 204 of a Publicly-held Corporate Pharmacy (“PCP”) 600. A pharmacy organization 200 of PCP 600 may be comprised of a number of pharmacies 204 which are arranged into a hierarchy of administrative and management regions 202 with a corporate-level administrative and management function 206.

The health care facilities 104 regularly submit census data for their patient population to a processing center 400 of the PCP 600. Census data may include such information as patient identification and demographics, health care facility identification, admission (or re-admission) date, facility unit, room number, bed number, payment plans, physician information, hospital discharge date, and responsible party information. Likewise, the pharmacies 204 send transaction data to the processing center 400 for supplies sold to the health care facilities 104 for use by particular patients. Transaction data may include such information as a description of the items sold, quantity, patient name, price charged and transaction date. The census and transaction information is preferably sent via an electronic communications network 414, such as an intranet or the Internet. The interconnectivity provided by the electronic communications network 414 is represented by link “A” in FIG. 1.

The electronic communications network 414 preferably includes one or more means of protecting the data in order to ensure patient privacy and to prevent data tampering and alteration. Protection means may include, but are not limited to, passwords, partitioning of data, encryption of data, and virtual private networks (“VPNs”). In addition, access to some data, such as patient information, may be restricted on a “need to know” basis to protect privacy. The availability of data and reports may also be partitioned such that predetermined users within the health care organization and PCP have predetermined levels of access to data and reports as appropriate for each particular user. The use of an electronic communications network 414 facilitates accurate, rapid transmission and reception of patient data, invoice information, reports, and messages.

The census and transaction data are collected by the processing center 400 at 402, along with previously stored data such as, for example, the “average wholesale price” for the supplies and prescription benefit terms and coverage. The previously stored data is generally termed herein as “contract data” 412. The collected census, transaction, pricing, and contract data is then organized at 404 to form a related “dataset” of correlated patient and pharmacy transaction data to facilitate queries, reporting, and further processing. The dataset may be organized in the form of a “data warehouse.” A data warehouse is a process by which large quantities of related data from many operational systems is merged into a single, standard repository to provide an integrated information view based on logical queries. Types of logical queries may relate to “data mining,” which can be defined as a process of data selection, exploration and building models using vast data stores to uncover previously unknown patterns. Other queries may be in support of research on a particular subject. The data warehouse is a valuable tool that can provide information for use in a wide variety of therapeutic, statistical, and economic analyses and interventions to aid the PCP and health care organizations in making health care and business related decisions. The data warehouse can also provide feedback regarding the impact of prior decisions, facilitating improvements in patient care, operational efficiency, and reducing the cost of medical care.

After the data is organized at 404, the pharmacies 204 may utilize the electronic communications network 414 to extract data at 410 such as census information, pricing, co-pay and contractual terms in order to validate the accuracy of the transactions. Validation activities may include determining whether the proper prescriptions have been charged to the patient and validating the accuracy of the prices charged in the transactions. The validation process may be automated if desired, such as by the use of a computer program. The pharmacies 204 may also use this information to determine whether and how the transaction charges must be allocated among a plurality of obligors (referred to generally herein as “payors”) for payment 502. Payors may include primary and secondary insurers, patients and responsible third parties. If any discrepancies are found, such as pricing errors, the transaction data is corrected by the pharmacy 204 via the electronic communications network 414. The processing center 400 is notified via the electronic communications network 414 when the pharmacy 204 has completed the validation process.

Once the processing center 400 has been notified that the pharmacy 204 has validated the transaction and allocated the charges, an invoice is created at 406. The responsible health care facility 104 may then obtain the invoice electronically via the electronic communications network 414. The invoice may optionally include “links,” such as Hypertext Markup Language (“HTML”) that provide the reviewer with online access to more detailed information regarding the charges. The health care facility 104 may then examine the charges listed on the invoice and compare them to their records. If any discrepancies are found, the facility 104 may utilize the electronic communications network 414 to request a credit memo. The credit memo is received by account representatives 304, who then adjudicate the request as either accepted or rejected. The account representatives 304 may then notify the facility 104 of the disposition of the credit memo request via the electronic communications network 414, thus reconciling the discrepancy.

The dataset organized at 404 may be used to create a wide variety of reports having a predetermined format at 408, with the amount of information being made available on a predetermined basis to particular levels of users. For example, reports particular to a certain health care facility 104 may be used by that health care facility to manage their operations and evaluate their business performance. The reports may be obtained via the electronic communications network 414. Similarly, administrative and management personnel at the regional level 102 of the health care organization 100 may obtain online reports via the electronic communications network 414 for each facility 104 in the regional facility group and also make comparisons between facilities within the region 102. At the corporate level 106, administrative and management personnel may obtain reports via the electronic communications network 414 pertaining to all levels within the health care organization 100, such as individual facilities 104, comparisons between facilities, summary data for regional groups 102, comparisons between regions, and overall performance of the organization 100. The reports may be formatted to include such information as “top 10” expense patients by facility, summaries of drugs prescribed, intravenous (“IV”) drugs used, facility metrics outside a set standard deviation, usage of certain medication groups, drug utilization, formulary compliance, cost per patient day, and metrics by payment plan. The reports may be based on data accumulated over a set period of time, such as a monthly report. In addition, trends over longer periods of time may be analyzed using historical information coupled with current data.

Reports may also be made available to the PCP and pharmacies on a hierarchical basis to classes of users. The pharmacies 204 may obtain reports at 408 that are pertinent to their operation, via the electronic communications network 414. At the regional pharmacy group level 202, administrative and management personnel may obtain business performance reports via the electronic communications network 414 for each pharmacy within the regional pharmacy group and make comparisons between the pharmacies. At the corporate level 206, administrative and management personnel may obtain via the electronic communications network 414 a variety of reports pertaining to all levels of the organization, such as individual pharmacies 204, comparisons between pharmacies, performance of regional pharmacy groups 202, comparisons between regional pharmacy groups, and overall performance of the pharmacy portion 200 of the PCP 600. Reports may include information regarding “top ten” facilities by Medicare rate, accounts receivable, drug utilization, formulary statistics, customer survey results, census data, and credit memos.

Account representatives 304 within a customer service portion 300 of the PCP 600 may likewise obtain reports at 408 via the electronic communications network 414 in order to analyze the activity at the facilities 104 and pharmacies 204 for their accounts. Administrative and management personnel at the regional group level 302 may access data via the electronic communications network 414 for all facilities 104 and pharmacies 204 within their region. At the corporate level 306, administrative and management personnel may obtain via the electronic communications network 414 a variety of data pertaining to pharmacies 204, facilities 104, pharmacy regional groups 202, and health care regions 102.

The electronic communications network 414 preferably has at least one way to protect against unauthorized access and tampering with the reports. In addition to restricting access to various reports on a “need-to-know basis” as described in detail above, other security measures include, but are not limited to, passwords, partitioning of data, encryption of data and virtual private networks (“VPNs”).

Data organized at step 404 may be de-identified in a manner so as to be compliant with patient privacy regulations such as those found in the U.S. Health Insurance Portability and Accountability Act (“HIPAA”). In particular, 45 C.F.R. Parts 160 and 164 of the Act relate to standards for privacy of individually identifiable health information (the “Privacy Rule”), promulgated by the Department of Health and Human Services (HHS). In part the privacy rule can restrict the acquisition and use of certain types of patient data, particularly individually identifiable health information. It should be noted that “de-identifying” patient data can entail more than merely redacting the patient's name. This is due to the fact that other patient information such as demographics, medical information, and health care facility information could be used separately or in combination to discern the identity of some patients. De-identification can involve the deletion or alteration of some portion of patient data to protect patient privacy, while preserving the overall statistical and analytical integrity of the data.

The electronic communications network 414 provides a common framework for invoicing, reporting, messaging, data exchange and communication between the health care organization 100, the pharmacy portion 200, the customer service portion 300, and the processing center 400. For example, the facilities 104 may direct questions to the customer service portion 300 regarding operational issues 308, nursing questions 310, clinical drug questions 312, billing questions 314, and computer-related questions 316. The electronic communications network 414 may also be utilized to share information such as company or industry news, open issues, and suggestions or helpful hints.

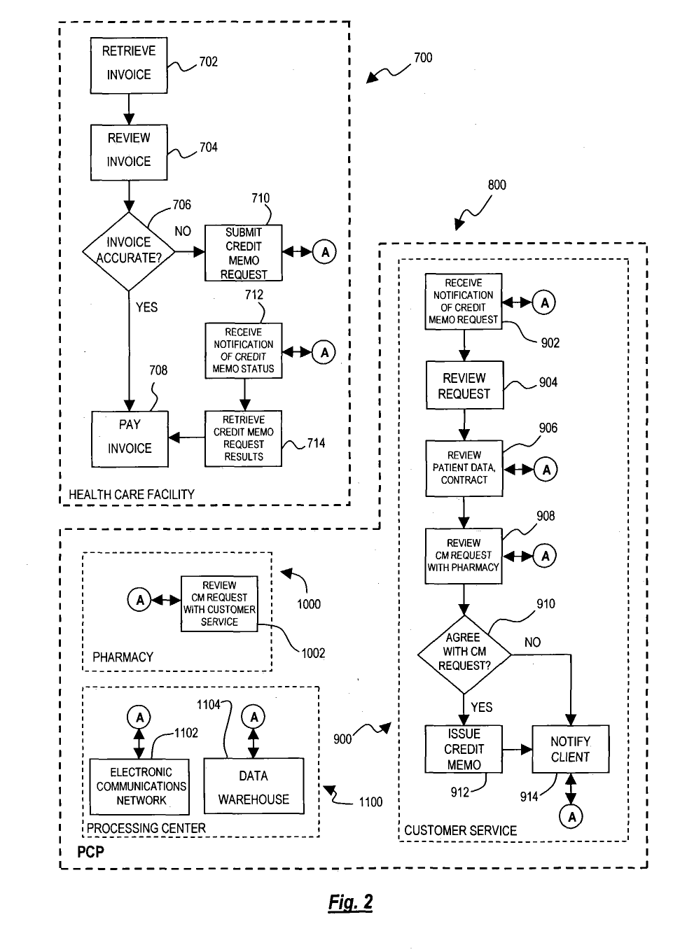

FIG. 2 is a block diagram of a method for handling credit memo requests in accordance with an embodiment of the present invention. At 702 a health care facility 700 may utilize an electronic communications network 1102, such as an intranet or the Internet, to retrieve an invoice from a repository, such as a data warehouse 1104 of the PCP 800. The interconnectivity provided by the electronic communications network 1102 is represented by link “A” in FIG. 2. The facility 700 reviews the invoice at 704, and determines at 706 whether the invoice is accurate. If the invoice is accurate, the facility 700 pays the invoice at 708. If a discrepancy is found, at 710 the facility 700 submits a credit memo request to a customer service portion 900 of the PCP 800. The request may be submitted via the electronic communications network 1102. The request includes a notification 902 that is sent to a customer service portion 900 of the PCP 800. The customer service portion 900 reviews the credit memo request at 904, and may also obtain patient data and contract or payment plan data at 906 via the electronic communications network 1102, if such information is needed to make a credit determination. At 908, 1002, the customer service portion 900 and pharmacy portion 1000 may review the transaction for accuracy. The transaction information may be accessed by the pharmacy 1000 and the customer service portion 900 via the electronic communications network 1102. The customer service portion 900 makes a determination at 910. If the customer service portion 900 agrees with the request, a credit memo is issued at 912 and the client is notified at 914 via the electronic communications network 1102. If the credit memo request is denied, the client is likewise notified at 914 via the electronic communications network 1102. It should be noted that a credit memo request may include multiple items which may be decided upon on an item-by-item basis by the customer service portion 900, with credit requests being accepted for some items and denied for other items. The health care facility 700 receives a notification of the disposition of the request at 712, and retrieves the results at 714. The invoice is paid at 708.

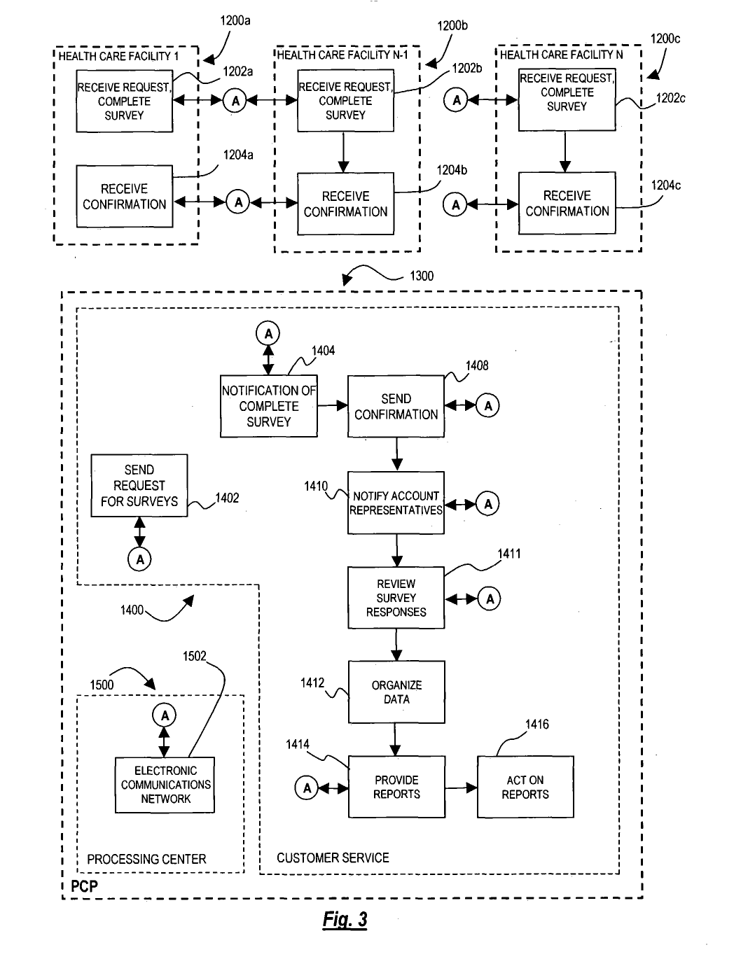

FIG. 3 is a block diagram of a method for handling surveys and customer feedback in accordance with an embodiment of the present invention. At 1402 a customer service portion 1400 of a PCP 1300 sends a request to health care facilities 1200a-c via an electronic communications network 1502, such as an intranet or the Internet. The interconnectivity provided by the electronic communication network 1502 is represented by link “A” in FIG. 3. It should be noted that facilities 1202a-c of FIG. 3 are intended to generally represent any desired grouping of facilities, such as individual facilities, regional groups of facilities, and all of the facilities of a health care organization. At 1202a-c the facilities receive a message requesting that the survey be completed, and proceed to answer the questions via the electronic communications network 1502. When the survey has been completed, the customer service portion 1400 will receive a notification 1404 via the electronic communications network 1502. At 1408 the customer service portion 1400 may send the facilities 1200a-c a confirmation and thank-you note via the electronic communications network 1502, the confirmation and note being received by the facilities at 1204a-c. The account representatives of the customer service portion 1400 responsible for the facilities 1200a-c are notified via the electronic communications network 1502 at 1410 that the surveys have been received. The account representatives may then access the surveys at 1411 via the electronic communications network 1502. The survey data may be organized at 1412 to facilitate reports at 1414. The reports may be obtained via the electronic communications network 1502. The reports can be used by administrative and management personnel of the PCP 1300, such as account representatives, to analyze customer satisfaction by organizing the data in any desired fashion, such as by individual facilities or regional groups of facilities. Action items such as corrective actions to resolve customer dissatisfaction, may be defined and acted upon at 1416. The electronic communications network 1502 can also be utilized to organize “virtual” focus groups for inquiries regarding interest in particular new products, and the performance of current products.

As can be seen, the disclosed invention facilitates more rapid and more accurate invoicing for transactions, and provides for a number of useful reports. From the above description of the invention, those skilled in the art will perceive improvements, changes, and modifications in the invention. Such improvements, changes, and modifications within the skill of the art are intended to be covered.

What is claimed is:

1. A method for improving the accuracy of monetary charges to payors in a transaction, comprising the steps of:
a) collecting census data from at least one first source by means of an electronic communications network;
b) collecting transaction data from at least one second source by means of the electronic communications network;
c) correlating the census data and the transaction data with existing payor contract data to form a related dataset;
d) validating the dataset for accuracy; and
e) allocating monetary charges to at least one payor based on the dataset.

2. A method according to claim 1, further comprising the steps of enabling at least one of the first and second source, by means of the electronic communications network, to:
a) access the dataset and the allocated charges;
b) compare the allocated charges with records maintained by the accessing source; and
c) reconcile discrepancies between the first and second sources regarding the charges.

3. A method according to claim I further comprising the step of protecting the census data, the transaction data and the dataset from unauthorized access.

4. A method according to claim 1, further comprising the step of protecting the data and the dataset from unauthorized alteration.

5. A method according to claim 1, further comprising the step of generating reports from the dataset.

6. A method according to claim 5, further comprising the step of compiling the dataset into predetermined report formats.

7. A method according to claim 5, further comprising the step of distributing the reports to predetermined users.

8. A method according to claim 7 wherein the reports are distributed via the electronic communications network.

9. A method according to claim 7, further comprising the step of classifying the dataset and reports into predetermined access levels for controlling the extent of access to the dataset and reports by the predetermined users.

10. A method according to claim 5, further comprising the step of protecting the reports from unauthorized access.

11. A method according to claim 5, wherein patient-identifying information has been removed from the dataset.

12. A method for improving the accuracy of monetary charges to payors in a transaction, comprising the steps of:
a) collecting census data from at least one first source by means of an electronic communications network;
b) collecting transaction data from at least one second source by means of the electronic communications network;
c) correlating the census data and the transaction data with existing payor contract data to form a related dataset;
d) validating the dataset for accuracy;
e) allocating monetary charges to at least one payor based on the dataset;
f) enabling at least one of the first and second sources, by means of the electronic communications network, to:
i) access the dataset and the allocated charges,
ii) compare the charges with records maintained by the source, and
iii) reconcile discrepancies between the first and second sources regarding the charges; and
g) generating reports from the dataset.

13. A method according to claim 1 wherein the first source further comprises a hierarchy of individual facilities, facility groups comprising a plurality of individual facilities, and corporate oversight of the facilities and groups of facilities.

14. A method according to claim 1 wherein the second source further comprises a hierarchy of individual pharmacies, pharmacy groups comprising a plurality of individual pharmacies, and corporate oversight of the pharmacies and groups of pharmacies.

15. A method according to claim 1 wherein the electronic communications network is used to transmit and receive messages between the first source, the second source, and a processing center.

16. A method according to claim 1, further comprising the steps of:
a) conducting logical queries using the dataset; and
b) analyzing the results of the logical queries.

17. A method according to claim 5 wherein the reports relate to the business performance of pharmacies and groups of pharmacies.

18. A method according to claim 5 wherein the reports relate to the business performance of facilities and groups of facilities.

19. A method according to claim 15, further comprising the steps of:
a) conducting a survey via the electronic communications network;
b) obtaining responses to the survey via the electronic communications network; and
c) taking corrective action to resolve problems identified by the survey.

20. A method according to claim 15, further comprising the steps of transmitting and receiving communications between the first source and the second source regarding interest in particular new products and the performance of current products.

21. A method according to claim 1, further comprising the steps of:
a) generating reports from the dataset;
b) distributing the reports to predetermined users via the electronic communications network;
c) classifying the dataset and reports into predetermined access levels for controlling the extent of access to the dataset and reports by the predetermined users;
d) protecting the reports from unauthorized access; and
e) removing patient-identifying information from the dataset.
